(19) United States
(12) Patent Application Publication
(10) Pub. No.: US 2003/0078779 A1
(43) Pub. Date: Apr. 24, 2003

(54) Interactive voice response system

(76) Inventors: Adesh Desai, Northridge, CA (US); Alexander L. Kovatch, Newport Beach, CA (US); Sanjeev Kuwadekar, Northridge, CA (US); Deepak Sodhi, Northridge, CA (US)

Correspondence Address: Wen Liu, LIU & LIU LLP, 811 West 7th Street, Suite 1100, Los Angeles, CA, 90017, US

(21) Appl. No.: 10/188,585

(22) Filed: Jul. 3, 2002

Related U.S. Application Data
(63) Continuation of application No. PCT/US01/00376, filed on Jan. 4, 2001.
(60) Provisional application No. 60/174,371, filed on Jan. 4, 2000.

(51) Int. Cl. G10L 15/18

(52) U.S. Cl. 704/257

(57) ABSTRACT

A voice response system and method for navigating any network and using facilities and applications provided by various destination nodes within the network. No change is required in the applications provided by the destination nodes. A user can control and navigate the system with no prior knowledge of the system via self-discovery facilities provided as part of a learning system that adapts itself to the user.

This is a Continuation of International Application PCT/US01/00376, with an international filing date of Jan. 4, 2001, which claims the priority of U.S. Provisional Application No. 60/174,371 filed Jan. 4, 2000.

### BACKGROUND OF THE INVENTION

1. Field of the Invention

The present invention relates to voice-based interactive user interfaces, particularly to interactive voice response systems, and more particularly to interactive voice response systems for accessing information from a computer network via remote telephony devices.

2. Description of Related Art

Voice mail and other interactive voice response (IVR) systems allow a user to access audio information stored in a computer memory such as a hard disk. Typically, the audio information is stored in audio files created either by the user or for the user. Conventional IVR systems use dual-tone multi-frequency (DTMF) signalling to allow the user to interact with the server through a standard telephone keypad. Pre-recorded audio information is available on IVR systems in the form of instructional phrases such as “Please type in your account number followed by the pound sign.”

Pre-recorded audio is also used for introductory phrases such as “Your account balance is . . . ” At this point, the IVR computer may access a connected database that stores the requested account balance in numerical format, convert the numerical format to an audio format using a numerical text-to-speech engine, and state the account balance. This conversion from numerical format to audio format is extremely rigid and completely predefined. IVR systems are “closed” in that each IVR system is uniquely designed, not connected to a computer network, and IVR systems cannot be used interchangeably. Also, these IVR systems are designed specifically for audio interaction.

In contrast, audio/visual information on an audio/visual server in a computer network may be accessed using a personal computer. For example, a World Wide Web (Web) page on the Internet may be accessed using a computer linked through an Internet access provider, such as America On Line™. or Prodigy™, to a Web server.

The Internet has emerged as a mass communications, commerce and entertainment medium. Worldwide, people are enabled to interact, distribute and collect information, create community with individuals sharing similar interests and make purchases electronically. According to International Data Corporation (“IDC”), worldwide e-commerce totaled approximately $32 billion in 1998 and is expected to total over $425 billion in 2002. IDC also projects that worldwide Internet use will grow from approximately 142 million users in 1998 to 502 million users in 2003. In light of the proliferation of Internet usage, Forrester Research projects that global online advertising spending will reach $33 billion by 2004, while online advertising in the U.S. will grow from $2.8 billion in 1999 to $22 billion in 2004.

The growth of the Internet over the past five years has been nothing short of spectacular, particularly in the U.S. This proliferation however, is largely confined to westernized countries. Recent studies by Commerce Net and the Stanford Institute for the Quantitative Study of Society have yielded some startling results:

92% of the world's population has no access to the Internet

90% of the U.S. population also has no access to the Internet at least half of the time

People are more mobile than ever before

Cell phone penetration is rapidly increasing

A quarter of the U.S. population is apprehensive about or experiences difficulty using computers and the Internet

Further, in certain situations, however, use of a computer may not be feasible or access to a computer may not be possible. For example, a cellular telephone user driving an automobile may want to know about traffic in the surrounding area, however, the user cannot operate a computer while in the car. In situations such as this, an audio interface may be useful for obtaining information from the Internet or another computer network.

Other situations where an audio interface to a computer network may be useful include accessing an electronic calendar on a local area network (LAN) to receive or modify an itinerary, accessing E-mail on the Internet or a wide-area network (WAN) while away from a computer, and requesting a telephone number from an electronic yellow pages or white pages while at a pay phone. An audio interface to the Web could also be used to traverse the Internet and obtain information residing on various Web servers.

The telecommunications industry has experienced strong growth over the last decade. Despite its growth, the highly fragmented telecommunications industry is being changed by the emergence of the Internet as a global medium for communication, news, information and commerce. Substantial portions of the commerce and advertising markets remain uncaptured. The proliferation of Internet, cellular and telecommunications users, combined with the global reach and lower cost of distribution in such arenas, have created a powerful channel for delivering entertainment and information and conducting related advertising and commerce.

It is interesting to note that each area code enables nearly 8 million separate telephone numbers and the total number of area codes in service has nearly doubled since 1991, growing from 119 to 215, according to the FCC. In California alone, the California Public Utilities Commission expects the number of area codes in service to increase from 13 in January 1997, to 40 by 2002. A significant portion of this growth is due to the rapid proliferation of cellular and PCS telephone service. The number of U.S. wireless subscribers is expected to grow to 149 million in 2003, representing a wireless market penetration of 53%. The global wireless penetration is expected to increase from 425 million in 1999 to 953 million in 2003.

U.S. Pat. No. 5,884,262 discloses a computer document audio access and conversion system that allows a user to access information originally formatted for audio/visual interfacing on a computer network via a simple telephone. Of course, files formatted specifically for audio interfacing can also be accessed by the system. A user can call a designated telephone number and request a file via dual-tone multi-frequency (DTMF) signaling or through voice commands. The system analyzes the request and accesses a predetermined document. The document may be in a standard document file format, such as hyper-text mark-up language (HTML) which is used on the World Wide Web. The document is analyzed by the system, and depending on the different types of formats used in the document, information is translated from an audio/visual format to an audio format and played to the user via the telephone interface. The document may contain links to other documents that can be invoked to access such other documents. In addition, the system can have a native command capability that allows the system to act independently of the accessed document contents to replay a document or carry out functions similar to those available in conventional web browsers.

The system disclosed in U.S. Pat. No. 5,884,262 is limited to handling information originally formatted for audio/visual interfacing to a computer network via a telephone. There is a need for flexible interactive access to information that is not originally formatted for audio interfacing to a computer network via telephony devices. There is a need for interactive telephony access to a computer network, such as the Internet, to expand and enrich usage with unique and compelling content and products.

### SUMMARY OF THE INVENTION

The present invention is directed to an interactive voice response system that permits users to access information that is not originally formatted for audio interfacing to an information exchange network, such as a computer network. Users spoken utterance is analyzed and matched with an index of destinations. A list of valid destinations is produced and the user is the guided along the path with pre-recorded voice prompts. The user accessing the system can control the navigation via more speech and/or telephone keypad entry. The intent of the system is to be able to come up with a single choice destination amongst the many offered within the system.

The decision to choose a valid destination is driven by a variety of factors

User preferences

User profile derived from usage pattern history

User responses

Advertiser rules

Utterance match weightage

Active context

Call origin

Call date/time

Call length

The destination that is derived earlier is then accessed via spoken utterance and/or telephone keypad entry. User specific information about the destination is derived from the user profile and the current call context and is used to offer access to the facilities offered by the destination. The facilities offered are specific to the application provided by the destination node.

User responses and queries are appropriately translated to the destination format and vice versa. All of the interaction is via concatenated pre-recorded or synthesized voice segments or fragments.

The inventive voice response system includes a number of novel functional and logical components, including without limitations query engine, ad generator, web parser, profiler and replication engine, managed by a manager. These components may physical reside in the same or different servers.

The present invention will be described in reference to “HeyAnita”, and in the alternate “Anita”, which references relates to the commercial system launched by HeyAnita, Inc. (www.heyanita.com).

HeyAnita Inc.'s proposed solution is to enable the world's population to access, by voice, the wealth of information and applications available on the Internet, using any type of phone—rotary, touchtone or wireless. The rationale behind this vision is threefold:

1. Everyone knows how to use a telephone.

2. Most cities in the world already have reliable land-line phones as well as wireless infrastructure.

3. The easiest user interface is the speaker's natural language, both spoken and heard.

As competition within Internet and cellular usage intensifies, high traffic Internet portals, other e-commerce providers and traditional companies will continue to seek ways to expand and enrich their consumer offerings with unique and compelling content and products. This will create significant opportunities for HeyAnita to connect eyeballs to eardrums, thereby enabling these companies to target and reach a significantly expanded audience.

### BRIEF DESCRIPTION OF THE DRAWINGS

FIG. 1 is a schematic representation of the Anita Server Architecture.

FIG. 2 is a schematic representation of the logical internal structure of Anita Server.

FIG. 3 is a schematic representation of the overall HeyAnita global infrastructure that comprises Anita Servers in various countries, cities, and other locales.

FIG. 4 illustrates one embodiment of a “tree” structure that exemplifies how clarification questions would be asked while narrowing down a search.

FIG. 5 is a schematic representation of the HeyAnita Operating System.

### DETAIL DESCRIPTION OF THE INVENTION

The present description is of the best presently contemplated mode of carrying out the invention. This description is made for the purpose of illustrating the general principles of the invention and should not be taken in a limiting sense. The scope of the invention is best determined by reference to the appended claims.

The present invention will be described below in reference to the Internet as an example of an information exchange network. The present invention is applicable to other types of information network without departing from the scope and spirit of the present invention.

The HeyAnita Solution

HeyAnita enables individuals to surf the Internet from any phone, anywhere, anytime simply by using their voice. By utilizing its revolutionary HeyAnita operating system (“HeyAnita OS”) technology and easy to use interface, HeyAnita establishes a comprehensive Voice Internet Portal (“VIP”), providing a voice interface to the Internet and allowing Internet and telephone users to access volumes of information, headline news, stock quotes, horoscopes, auctions, food delivery services, weather forecasts, sports scores, travel, shipping status, free integrated voice mail, and much more. In addition, HeyAnita enables e-commerce providers to add voice application (v-application) services to their existing platform and enables traditional corporations to efficiently compete in the digital arena. HeyAnita's unique solution increases traffic and commerce by providing access to individuals who do not use traditional Web-based browsers and also allows traditional Internet users access from locations lacking connectivity.

HeyAnita uses its proprietary technology and easy to use interface to create an informative and entertaining environment to attract and retain a large and loyal user base. In addition to its easily brandable name and concept, HeyAnita offers the most comprehensive array of voice enabled services and allows phone users to access the Internet in multiple languages. Appendix B sets forth some of the application features possible with the inventive HeyAnita system.

Architecture

HeyAnita Voice Platform is a set of components based on Microsoft Windows DNA architecture that allows developers and power-users to rapidly develop and deploy speech applications. The platform is an open environment that encapsulates a speech recognition engine, audio input sources (speaker, telephone) and audio output sources (speaker, telephone). It provides a vendor independent interface to the voice application by providing a consistent interface to the various audio devices and the speech recognition engine.

Any application written to these interfaces can be ported from one device to another or from one speech recognition vendor to another merely by creating the appropriate object. For example, developers can develop and test their voice applications using a PC speaker and a microphone and then move the application to the telephone just by creating objects that support the telephone device.

The primary design considerations, features and functionalities for the HeyAnita Voice Platform are:

Device Transparency: HeyAnita Voice Platform is not tied to any hardware device. It provides plug-and-play flexibility to switch the underlying hardware without having to modify the actual application. Because of this, developers do not need any special hardware to write and test their applications. They will be able to write their applications on standard Microsoft Windows PCs and deploy them on any telephony platform.

Speech Recognition Engine Transparency: HeyAnita Voice Platform is not tied to any specific speech recognition engine. It provides plug-and-play flexibility to switch the underlying speech recognition engine without having to modify the actual application. Developers will be able to develop applications on any shareware speech recognition engine and later deploy them on any of the popular commercial speech recognition engines such as Speechworks or Nuance.

Language of Choice: HeyAnita Voice Platform does not force developers to learn a new language such as VXML. In addition to W3C VXML, HeyAnita Voice Platform allows developers to write applications in a language of their choice. For instance, any COMcompliant language such as Visual Basic, Visual C++ or Java can be used to develop applications on the HeyAnita Voice Platform.

Rich VUI: HeyAnita Voice Platform's open architecture allows developers to plug in third-party components to make their Voice User Interfaces richer. Developers do not have to settle for mediocre Voice Interfaces because of the limitations in the platform or language.

Location Transparency: HeyAnita Voice Platform allows developers to host their applications on any server on the Internet. All the pieces of HeyAnita Voice Platform are developed with location transparency in mind.

Multiple Language Support: HeyAnita Voice Platform has been designed to support international languages. Any application written on HeyAnita Voice Platform can be localized in any international language without any code changes.

HeyAnita Voice Platform/HeyAnita OS:

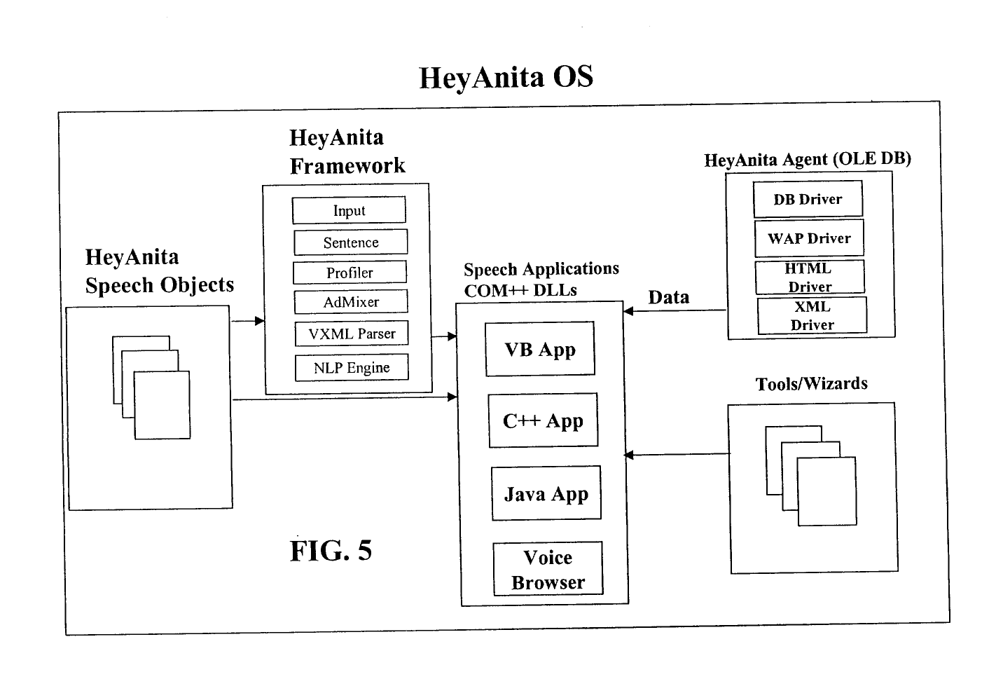

HeyAnita OS is a multi-threaded surrogate process that hosts all the HeyAnita components and application objects. It takes care of all the thread management and monitoring, administration so that applications writers do not have to worry about issues such as thread synchronizations. FIG. 5 shows the components of the HeyAnita OS (100).

HeyAnita Speech Objects (110):

These are a set of COM+components that encapsulate hardware devices and speech recognition engines. Once the applications are written using these interfaces, they can be ported easily from one hardware device to another or from one recognition engine to another by simply replacing the corresponding HeyAnita Speech Object.

Speech Recognition Manager (SR)—This object encapsulates the speech recognition engine and the text to speech engines and provides a consistent interface to these engines in a vendor independent fashion.

Audio Source (AI)—This object encapsulates the audio input device and provides a consistent interface in a device independent fashion.

Audio Destination (AO)—This object encapsulates the audio output device and provides a consistent interface in a device independent fashion.

Grammar Object (GO)—This object provides a consistent interface to provide grammar files for speech recognition. The grammar files can reside anywhere on the Internet. The grammar object refers to the grammars files by URI.

Prompt Object (PO)—This object provides a consistent interface to provide prompts in speech applications. The prompts can reside anywhere on the Internet. The prompt object refers to the prompt files by URI.

A typical voice application will create a SR object for speech recognition, an Al object as an audio input object, an AO object as an audio output, a GO object for recognizing speech and several PO objects for the various prompts it may require. The application can then play the prompts using the audio out object, accept input using the audio in object and recognize the input using the speech recognition object while the grammar object gives context to the speech recognition object.

HeyAnita Agent (116):

HeyAnita Agent is a set of COM+ objects that allow speech applications to access data in a consistent manner. This makes speech applications transparent to the underlying data format. Applications access data in any OLE DB-compliant database, XML page, HTML page or WAP page using the same programming model.

Speech Applications (114):

Speech applications are written as a set of COM+ components or VXML files. These applications can be written in any COM-compliant language such as Visual Basic, Visual C++ or Java. It is also possible to write an application using multiple languages, e.g., it is possible to make use of a VXML file inside a Visual Basic speech application. This flexibility allows developers to write voice applications faster and in the language they are most comfortable with.

Applications written to HeyAnita speech platforms don't have to reside on the same server that the platform resides. These COM+components can be installed locally on the telephony server or any remote machine. In fact these applications can reside anywhere on the Internet. Applications on the Internet communicate with the platform using SOAP.

HeyAnita Tools/Wizards (118):

HeyAnita tools are a set of design time controls (DTCs) that allows the developers to quickly generate Speech Applications in a drag-and-drop fashion. Developers do not have to learn a new language such as VXML. All the code is generated by these design time controls. These tools are provided for all components included in the HeyAnita framework. In addition to the DTCs, add-ins are provided for Office to facilitate easy authoring of content.

Many components from the HeyAnita framework have associated metadata and data elements. Tools are provided for easy management of this content. Application wizards are provided for popular functions, such as a “shopping cart”, “get a stock quote” etc. In addition, since the HeyAnita wizard model is a Visual Studio DTC, developers can create their own wizards or extend existing ones.

HeyAnita Framework (112):

HeyAnita framework provides a number of plug-and-play COM+components to facilitate rapid development and deployment of voice applications. Using these components as building blocks and writing just the code to glue them together, programmers can create voice applications in a matter of hours. All the necessary voice user interface, grammars and functionality are implemented by these components. All the components contain the necessary audio prompts and grammars. Developers, however, have the ability to override these by customing their prompts or grammars.

This is an extensible, open framework. It allows developers to add new value-added components to this framework by simply exposing a set of published COM+interfaces. Most of the HeyAnita portal applications are built using this framework.

Depending on the functionality, these components fall into one of the following categories:

Basic Components: These are basic building blocks for constructing a voice application. When developers use these components, they automatically get consistent and easy-to-use voice interfaces across all their applications.

Data-bound components: These components implement standardized voice interface on top of commonly used data elements.

Value-added components: Value-added components provide all the bells and whistles for making voice user interface entertaining and fun-to-use.

Basic Components:

The HeyAnita framework may include the following basic components:

1. Sentence: Plays back a set of sentences.

2. Input: Gets voice command input from the user.

3. Menu: Implements smart voice menu.

4. Number: Plays back a number.

5. Currency: Plays back currency.

6. Date: Plays back date.

7. Time: Plays back time.

8. Credit Card: Gets credit card information from the user.

9. Social Security Number: Gets social security number from the user.

10. Name: Gets name information from the user.

11. Address: Gets address information from the user.

12. VXML Parser: Parses and executes a W3C compatible VXML stream.

Data-bound Components:

The HeyAnita framework may include the following data-bound components:

1. Stock Quote: Retrieves individual stock quotes.

2. Portfolio: Retrieves quotes for all the stocks in the portfolio. Also, allows the users to manage their portfolios.

3. Weather: Retrieves weather information

4. Movie Show Times: Retrieves movie show times

5. Movie Previews: Retrieves movie previews

6. Store/Service Locator: Locates a store or a service

7. Status Inquiry: Checks status of an order, shipment

8. Yellow Pages: Yellow page inquires

Developers will be able to bind these to any OLE DB provider or XML repository to retrieve the necessary data.

Value-Added Components:

The HeyAnita framework may include the following value-added components:

1. AdMixer: Selects advertisements based on the user's preferences and history.

2. Randomize: Randomizes selection of audio prompts (from a pre-defined set).

3. Joke-of-the-day: Selects a joke of the day.

4. Login: Allows users to login.

5. Registration: Allows users to register.

6. Debug: Adds debugging trace to the voice application.

Notifications/Alerts: Sends outbound notifications/alerts.

Anita Server

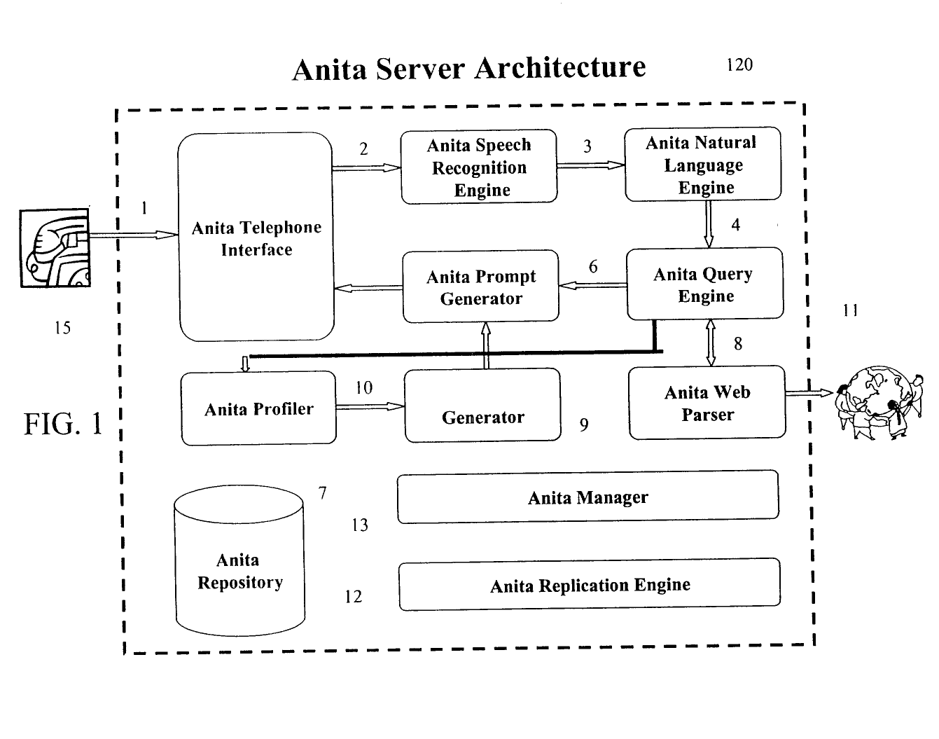

One of the primary components of the HeyAnita system is the Anita Server 120 (FIG. 1) that implements the HeyAnita Voice Platform, which consists of several components to implement the following functionality and features:

1. Wait for an incoming call

2. When a call is received, listen to user's voice as commands and/or free-form speech or telephone keypad entry

3. Decompose spoken utterance into proprietary commands using proprietary wordmapping techniques and voice recognition grammar

4. Ask relevant questions in order to determine user preferences and context

5. Identify the destination using proprietary search algorithms within the destination tree

6. Navigate to the destination and retrieve requested information

7. Translate retrieved information into voice prompts

8. Generate commercials based on user preferences, usage history patterns and context

9. Intermix commercials and information in a seamless manner to generate unique entertaining experience for the user

10. Return information back to the user in the form of concatenated speech fragments and/or synthesized voice

Anita Server—Architecture

FIG. 1 is a schematic representation of the Anita Server Architecture. The Anita Server 120 is a fault tolerant, scaleable, remotely manageable, multi-threaded NT Service. This comprises the following components:

a. Anita Telephone Interface (1)

Implements call management features such as ring and hangup detection, call switch-over, call transfer, call waiting and tromboning. This also implements functionality to transform computer audio files (.wav files) to audio streams that can be played on a telephone 15 and to detect user utterances on the phone line to pass them on to the Anita Speech Recognition Engine. This may be implemented using Dialogic system software version DNA 3.2 and Nuance Speech recognition system version 6.2.

b. Anita Speech Recognition Engine (2)

Translates spoken utterances to a set of text phrases. This engine supports a number of languages and is speaker independent. This may be implemented using Nuance Speech recognition system version 6.2. This engine serves as input to the Anita Natural Language Engine, described below.

c. Anita Natural Language Engine (3)

Converts natural language sentences to a set of structured commands. These structured commands are then used to drive Anita Query Engine. The Anita Natural Language Engine in conjunction with Anita Query Engine identify destination nodes and the applications that are available to the user. This engines serves as input to the Anita Query Engine, described below.

d. Anita Query Engine (4)

Maps commands to an application defined using the HeyAnita Speech Objects 110 and Speech Applications 114, or HeyAnita function library (see example in Appendix A) and state machine definition language. An example of an application would be to obtain weather information using Yahoo! Web site. This would provide a user of the system the capability of listening to weather information for a set of cities or zip codes. The Anita Query Engine does the following:

1) Play voice prompts for the user to exactly identify an application

2) Generate web URLs to initiate execution of the selected application

3) Hand over control to the Anita State Machine and Web Parser, described below

e. Anita State Machine and Web Parser (8)

Anita State Machine and Web Parser executes state machines written using a proprietary function library. This retrieves information web sites and other applications that are enabled for this operation. In addition, its web-parsing function also allows Anita Query Engine to retrieve web pages from any conventional web site on the Internet and convert unstructured HTML data into meaningful structured data. It is not mandatory to make changes to existing web sites to make them work with Anita State Machine and Web Parser. An example of this would be the operations performed to pass in a zip code to the Yahoo web site, execute the form to retrieve the results, select and format the results, play relevant information in the form of concatenated speech fragments. In this scenario the Yahoo! web site was not modified to support the operations nor was it aware that a voice-enabled application was using its HTML based services.

f. Anita Profiler (10)

During each user session, Anita Query Engine transfers relevant information to Anita Profiler. Anita Profiler captures and filters this information to build a repository of user preferences, navigational history and usage patterns. Anita Profiler recognizes the phone number of the incoming caller and can work without any user registration.

g. Anita Ad Generator/Mixer (9)

Implements complex algorithms to create an entertaining experience for the user by mixing advertisements and information in a seamless manner. This algorithm is based on a variety of factors such as user preferences and usage patterns, advertisers' rules and currently active context.

h. Anita Prompt Generator (6)

Converts text phrases to audio prompts. Unlike most other text-to-speech engine, Anita Prompt Generator implements algorithms to generate prompts in natural human voice using concatenated speech fragments rather than digitally created voice. However, in cases of completely unstructured text, Anita Prompt Generator uses Text-To-Speech software. This software may be based on Fonix Corporation TTS engine.

i. Anita Repository (7)

All the Anita components are meta-data driven. All the data required to drive these components is stored in Anita Repository. This allows Anita developers to generate new voice applications in a matter of hours by simply adding the necessary meta-data to Anita Repository. This meta-data is stored in the form of relational database tables.

j. Anita Replication Engine (12)

Smart replication engine that allows distribution of Anita Repository information to multiple Anita Servers in a reliable manner. This algorithm uses user preferences and usage patterns to replicate only the necessary information in order to avoid replication storms. In addition to Anita Repository data, Anita Replication Engine also distributes and applies software updates to all Anita Servers including itself.

k. Anita Manager (13)

Implements a set of standard interfaces for remotely monitoring and managing Anita Server components. These interfaces are used by Anita Toolbox to remotely monitor and manage Anita Server components.

Anita Server—Process

1. When a user calls, Anita Telephone Interface 1 receives the call and hands it over to Anita Speech Recognition Engine 2.

2. Anita Speech Recognition engine 2 converts spoken utterance into text and sends it to Anita Natural Language Engine 3 for further processing.

3. Anita Natural Language Engine 3 interprets Natural Language text and sends structured commands to Anita Query Engine 4.

4. Anita Query Engine 4 takes into consideration all of the governing factors such as user preferences, user context, usage patterns and history to determine an end destination node for the user's request.

5. Anita Query Engine 4 generates web queries needed to fulfill user's request and sends them to the Anita State Machine and Web Parser 8.

6. Anita State Machine and Web Parser 8 browses the Internet/web 11 to retrieve information requested by the user. It parses each received page to convert unstructured text into structured datasets.

7. While Anita State Machine and Web Parser 8 is busy retrieving the requested information, Anita Query Engine 4 asks Anita Prompt Generator 6 to generate context-sensitive voice prompts. It also sends a request to Anita Profiler to add generated queries to the user's profile.

8. Anita Prompt Generator 6 asks Anita Ad Generator 9 to create a set of entertaining commercials based on user's preferences and context.

9. Anita Ad Generator 9 asks Anita Profiler 10 for the user preference and usage history data and uses it to select appropriate commercials.

10. Anita Prompt Generator 6 creates an audio stream based on commercials and web information returned by Anita State Machine and Web Parser 8 and sends it to Anita Telephone Interface 12.

Anita Server—Logical Structure

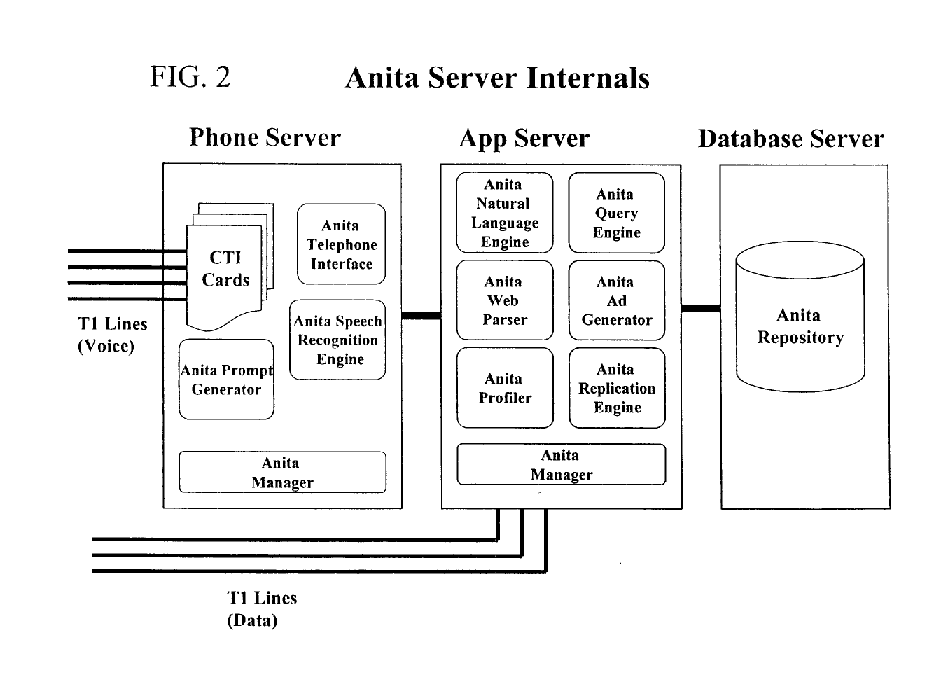

FIG. 2 is a schematic representation of the logical internal structure of Anita Server 120:

Anita Server 120 consists of three logical servers. These servers could be implemented on one physical box or multiple physical boxes based on the size and load at each Anita site. If they are implemented on multiple boxes, all the boxes are connected on a single high-bandwidth LAN segment.

a. Anita Phone Server (20)

Anita Phone Server 20 implements computer telephony interface using CTI hardware 21, Anita Telephone Interface 1, Anita Speech Recognition Engine 2, and Anita Prompt Generator6. It connects to one or more digital lines to accept telephone calls.

b. Anita Application Server (30)

Anita Application Server 30 implements Anita applications using Anita Natural Language Engine 3, Anita Query Engine 4, Anita State Machine and Web Parser 8, Anita Profiler 10 and Anita Ad Generator/Mixer 9. This server is connected to Internet using high-bandwidth lines. It also implements smart replication using Anita Replication Engine 13.

c. Anita Database Server (40)

Anita Database Server 40 implements Anita Repository 7 database.

Anita Toolbox

To complement the features and functions of the Anita Server, the Anita Toolbox (see FIG. 5, 118) provides a comprehensive set of tools to facilitate business partners and developers to:

1) Voice-enable existing web-sites and/or applications

2) Build voice-enabled v-applications. This uses the function library to build state machines that can be executed by the Anita State Machine and Web Parser

3) Remotely monitor and manage multiple Anita Servers

HeyAnita Infrastructure

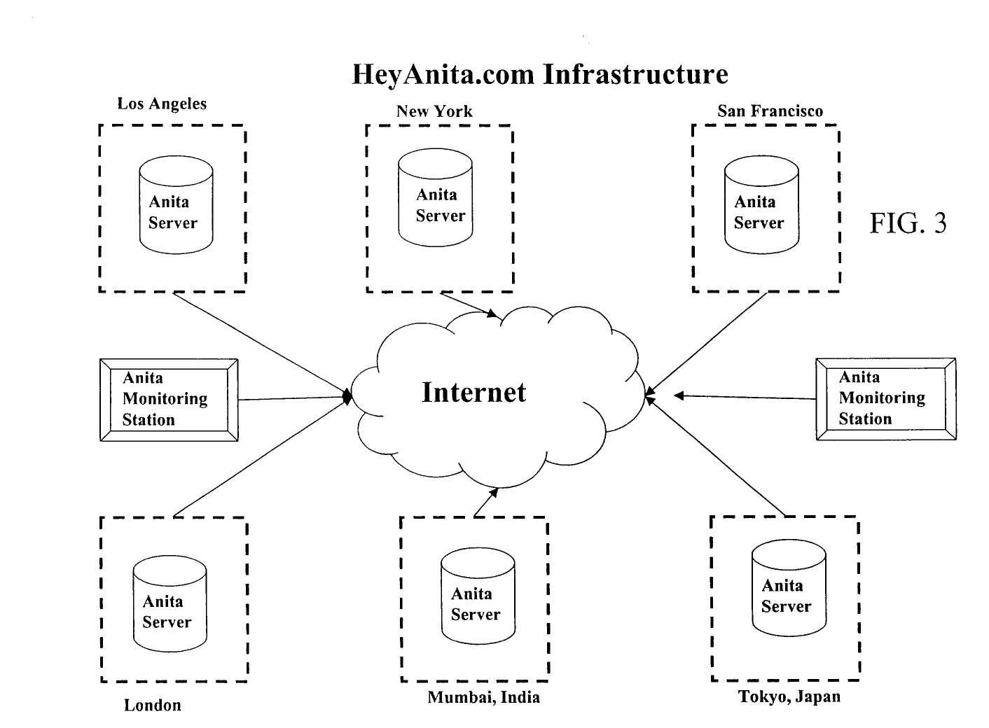

FIG. 3 is a schematic representation of the overall HeyAnita global infrastructure that comprises Anita Servers 120 in various countries, cities, and other locales. The Anita Servers 120 communicate with each other via a network such as the Internet 11. The Anita Replication Engine 12 in the Anita Servers 120 distributes Anita Repository 7 information to other Anita Servers 120. Anita Monitoring Stations 122 are provided to monitor and manage the interaction between the Anita Servers 120. The Anita Monitoring Stations 122 may be Anita Servers 120 which are configured for monitoring as their primary function. They may be similar to the Anita Managers 13.

HeyAnita Usage Scenarios

User Profile

User is registered with the system. She wants HeyAnita to recognize her based on the caller id of her phone without asking for any password/pin. She wants to travel to New York city and wants the system to help her make arrangements. She prefers using Expedia.com for Travel reservations and has a New York office in Manhattan.

Feature: Free Form Query

Users can use plain language utterances to navigate the system and interact with an automated attendant (“Assistant”) at HeyAnita.

Example 1: Weather

Assistant: How can I help you?

User: What is the weather forecast?

Assistant: Weather in your home city of Los Angeles is sunny and seventy degrees with a high expected to be seventy-six and a low expected to be sixty. Would you like the extended forecast for Los Angeles?

User: What's the weather like in New York?

Assistant: It's sunny and seventy degrees with a high expected to be seventy-six and a low expected to be sixty. Would you like the extended forecast for New York?

Example 2: Buying a CD

Assistant: How can I help you?

User: I want to buy the new Guns and Roses CD

Assistant: Please wait while I find the cheapest price for you. CD-now has it for eleven dollars and ten cents. Would you like to buy it now?

Example 3: Stock Quotes

Assistant: How can I help you?

User: I want to know the stock price for Microsoft

Assistant: Microsoft is currently trading at eighty-eight dollars.

Feature: Clarification Questions

If the user's query does not narrow the result set down to one destination then clarification questions are asked.

Example 1: Weather

Assistant: How can I help you?

User: Please tell the traffic conditions

Assistant: Please say the freeway and direction that you are interested in

User: 4 oh 5 South

Assistant: 405 South is clear from Northridge to Lax, then slows down to Long Beach, then is clear to Irvine

Example 2: Buying a CD

Assistant: How can I help you?

User: I want to buy CDs

Assistant: Would you like to buy CDs from Amazon, CD Now or find the cheapest price.

User: I like Amazon.

Assistant: Please tell me the name of the CD or the artist . . .

Example 3: Post Office Directions

Assistant: How can I help you?

User: Post Office

Assistant: Say stamps to buy stamps, say directions to get the directions to the post office or say shipping to get shipping status for parcels at the post office

User: I want directions.

Assistant: The nearest post office is . . .

Example 4: Travel to New York

Assistant: How can I help you?

User: I want to fly to New York tonight

Assistant: Please wait while I find the best fare using Expedia . . . . The fare to New York is $356. Would you like to buy it

User: Please do and book me a hotel near my office.

Assistant: Your preferred hotel Sheraton in Manhattan is $227. Would you like to book it

User: Please do and also get me a rental car.

Assistant: You are all set. Thanks for using HeyAnita

Upon Arrival in New York

User: I need directions to the hotel.

HeyAnita Recognizes that the Call Originates from a JFK Airport Phone Number

Assistant: Directions to your hotel in Manhattan.

Feature: Organized Catalog

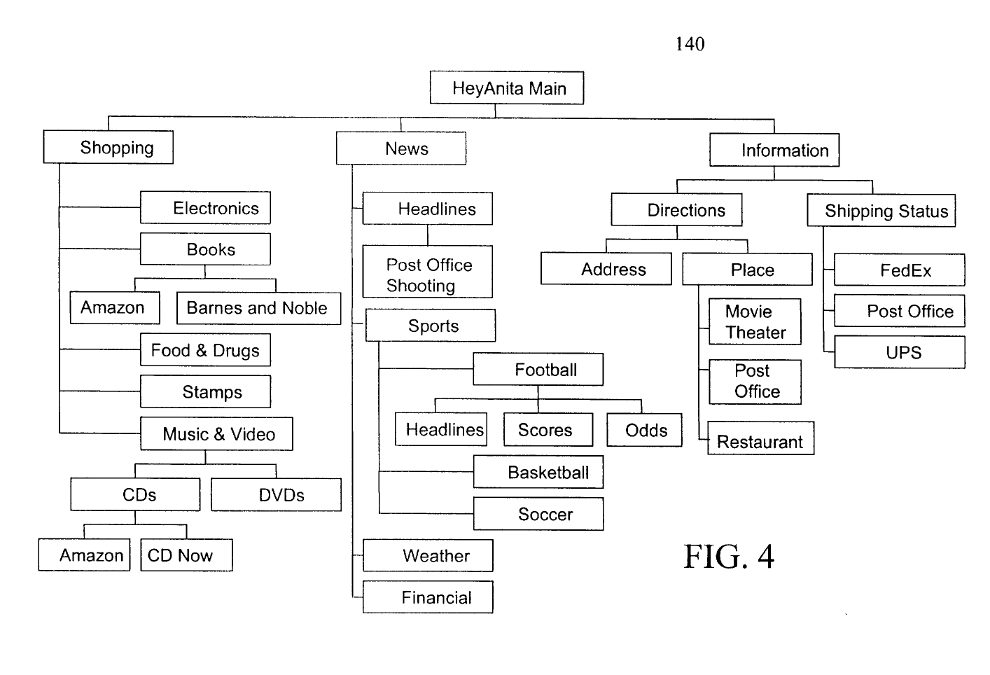

The way in which data is added and stored is also important creating a navigable application via the Anita Prompt Generator 6. Information is organized in a “tree” structure 140 as shown in FIG. 4. FIG. 4 demonstrates the organized tree of information which helps to show how the clarification questions would be asked while narrowing down the search.

Unlike with the Internet, the creator of a VRU can plan and control the creation and growth of this tree so that it remains usable.

Feature: Self-Discovering Features

While traveling down through the tree the user can discover the functions and features of the nodes below.

Each parent node describes the set of features in the child node.

Examples:

Shopping=Buy Books, Buy Electronics

Buy Electronics=Buy CD Players, Buy VCRs

News=Headlines, Weather, Financial Sports

Sports=Football, Basketball, Soccer

Football=Football Headlines, Football Scores, Football Odds

Football Headlines=ESPN Football Headlines, CBS Football Headlines

Feature: Context Sensitive Results

It is important to point out how this tree concept also gives context to the search as well. For example, if the user just said “Amazon” from the context of the main menu then the user would be asked if they wanted to “buy books from Amazon” or to “buy CDs from Amazon” but if the user said the same thing from the context of the books sub-tree then they would be taken directly to the section where they can buy books from Amazon.

Feature: User Preferences

HeyAnita is a learning system. It keeps on accumulating information about how users interact with it and modifies its search mechanism based on users' navigational history and preferences.

Example: If it finds that a particular user always buys books from Amazon, it will take him directly to “Buy Books from Amazon” when he says, “Buy Books”

While the invention has been described with respect to the described embodiments in accordance therewith, it will be apparent to those skilled in the art that various modifications and improvements may be made without departing from the scope and spirit of the invention. For example, the inventive concepts herein may be applied to wired or wireless telephony or other audio and voice access systems, based on the Internet, IP network, or other network technologies and protocols, for informational or other applications, without departing from the scope and spirit of the present invention. Accordingly, it is to be understood that the invention is not to be limited by the specific illustrated embodiments, but only by the scope of the appended claims.

[image]

[image]

[image]

[image]

[image]

[image]

[image]

[image]

[image]

[image]

[image]

1. An interactive audio response system that permits users to access information that is not originally formatted for voice interfacing to an information exchange network, comprising:
a voice interface for user to input request for information;
a speech recognition engine that converts user's spoken utterance from the voice interface into text;
a natural language engine that interprets the meaning and context embodied in the converted text and output structured commands;
a query engine that, in response to the structured commands, determines an end destination node for the user's request and generates corresponding web queries;
a web parser that, in response to the web queries, browses the web to retrieve information requested by user, and parses each received page from the web to convert unstructured text into structured datasets; and
a prompt generator that generates context-sensitive voice prompts to the voice interface in the event that an end destination node cannot be determined by the query engine.

2. A system as in claim 1, further comprising:
a profiler that stores user preferences and query history data from the query engine;
an ad generator that, in response to the prompt generator, generates a set of commercials based on user's preferences and context which was retrieved via the web parser.

3. A system as in claims 1 or 2, wherein the prompt generator generates voice prompts in accordance with a hierarchy tree structure.

4. An interactive system as in any one of claims 1 to 3, wherein the voice interface is a telephony interface.

5. An interactive system as in any one of claims 1 to 4, wherein the information exchange network is the Internet.

6. An interactive system as in any one of claim 1 to 5, wherein the system is based on an operating system comprising:
speech objects;
speech object COM++ DLLs;
an agent (OLE DB); and
a framework of plug-and-play COM+ components to facilitate rapid development and deployment of voice applications without reformatting information not originally formatted for voice interfacing.

7. An interactive system as in claim 6, wherein the framework comprises:
basic components for basic building blocks for constructing a voice application;
data-bound components that implements standardized voice interface on top of commonly used data elements; and
value-added components that provides value added features of the voice interface.
